(19) United States
(12) Patent Application Publication
(10) Pub. No.: US 2010/0057965 A1
(43) Pub. Date: Mar. 4, 2010

(54) Extension of Lock Discipline Violation Detection for Lock Wait Patterns

(75) Inventors: Yarden Nir-Buchbinder, Haifa (IL); Rachel Tzoref, Haifa (IL)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/202,084

(22) Filed: Aug. 29, 2008

(51) Int. Cl. G06F 12/14

(52) U.S. Cl. 710/200

(57) ABSTRACT

A computer usable medium including computer usable program code for detection of potential shared memory access deadlocks. The code determines, when a process waits on a first shared memory access lock, if the process holds locks other than the first lock. If so, then the code issues a warning about potential deadlock.

### BACKGROUND OF THE INVENTION

1. Field of the Invention

This invention relates to technology for detection of shared memory deadlock conditions.

2. Description of Background

A shared memory deadlock can occur when a first thread holds a first lock and then attempts to acquire second lock. If the second lock is held by a second thread, the first thread will be prevented from acquiring the second lock until the second thread releases the second lock. If the second thread attempts to acquire the first lock before releasing the second lock, the system will deadlock: neither thread can resume.

A problem addressed by the technology is the detection of certain types of deadlocks that are currently not detected by known static and dynamic analysis methods. Methods for deadlock detection typically try to discover lock discipline violation—i.e., cases where different processes or threads take locks nestedly in different orders. W. Visser, K. Havelund, G. Brat, S, Park, and F. Lerda. “Model Checking Programs”, Automated Software Engineering, 10(2), April 2003 describes such situations.

### SUMMARY OF THE INVENTION

The technology includes computer program products on a computer usable medium with code for detection of potential share memory access deadlocks. The technology includes code for determining, when a process waits on a first shared memory access lock, if the process holds locks other than the first lock. If so, the technology issues a warning about potential deadlock.

Additional features and advantages are realized through the techniques of the present invention. Other embodiments and aspects of the technology are described in detail herein and are considered a part of the claimed invention. For a better understanding of the technology with advantages and features, refer to the description and to the drawing.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the technology are apparent from the following detailed description taken in conjunction with the accompanying drawing in which:

FIG. 1 illustrates steps of a computer program product of the present technology.

### DETAILED DESCRIPTION OF THE INVENTION

As required, detailed embodiments of the present technology are disclosed herein. However, it is to be understood that the disclosed embodiments are merely exemplary of the technology that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present technology.

Known methods for handling deadlock situations ignore information about the wait synchronization primitive. After a thread takes a lock, it can call the wait primitive on that lock. As a result, the lock is temporarily released by the thread, there is a context switch, and when the operating system decides to resume the thread, the thread reacquires the lock. The thread can be resumed when some timeout is reached, or when it is notified by another thread that took the same lock, or if a certain exception occurs. A well known bug pattern related to the wait synchronization primitive is the “lost notify” bug pattern, where a thread waits on a lock and is never notified by another thread. This bug pattern is very hard to detect since it requires analysis of the possible future executions of the program's processes or threads. The technology disclosed hereon addresses potential deadlocks resulting from the use of the wait synchronization, for a subset of the “lost notify” bugs.

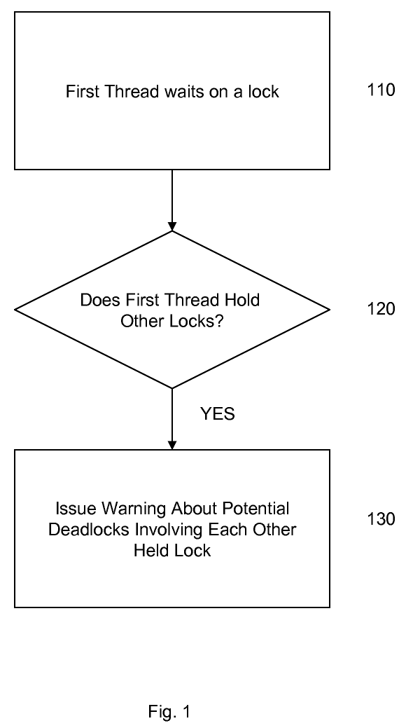

Referring to FIG. 1, whenever a first thread or a process 110 waits on a lock, the technology checks whether the first thread holds locks 120 other than the one it is about to wait on. If so, a warning is issued, preferably to a user, about a potential deadlock involving these locks 130. When a thread waits on a lock, it allows other threads waiting for that lock to advance since the lock is temporarily released. However, other locks that the thread may be holding are not released, and this can result in a deadlock, since other threads may be waiting for the other locks that the thread is holding. Consider for example the following as illustrated in FIG. 2: Thread 1 takes lock A, then takes lock B, then waits on A. Thread 2 takes lock A, then takes lock B, then notifies on A. There is no lock discipline violation since the locks were taken in the same order. However, if Thread 1 runs until it waits on A, then Thread 2 takes A, we reach a deadlock. In accordance with the present technology, when Thread 1 waits on A, a warning will be issued about a potential deadlock involving locks A and B. This warning is not issued by current methods for deadlock detection such as lock discipline violation.

The technology can be implemented by dynamic analysis—run-time monitoring on which locks are held by which processes/threads. When a thread is about to wait on a lock, we check if it is holding other locks. If so a warning is issued. The warning can be analyzed by the developer or tester of the system or by an automatic tool, and corrections can be introduced to the system to prevent the potential deadlock. The run-time monitoring can be implemented for example as a listener on top of the tool, e.g., the ConTest tool.

Another possible implementation is to make this check statically, by analyzing the code. There are known trade-offs between dynamic and static analyses.

The technology can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A computer program product comprising:
a computer usable medium including computer usable program code for detection of potential shared memory access deadlocks, said computer program product including;
computer usable program code for determining, when a process waits on a first shared memory access lock, if the process holds locks other than the first lock; and
computer usable program code for issuing a warning to a user about potential deadlock if the process holds locks other than the first lock.
